(19) United States
(12) Patent Application Publication
(10) Pub. No.: US 2022/0219297 A1
(43) Pub. Date: Jul. 14, 2022

(54) DOUBLE OVERMOLDED DISPLAY HOUSING ASSEMBLY

(71) Applicant: Snap-on Incorporated, Kenosha, WI (US)

(72) Inventors: Joshua M. Beer, Kenosha, WI (US); Jason Genz, Oak Creek, WI (US); Michael T. Rajzer, Greendale, WI (US); Craig Brouwers, Kenosha, WI (US)

(73) Assignee: Snap-on Incorporated, Kenosha, WI (US)

(21) Appl. No.: 17/144,777

(22) Filed: Jan. 8, 2021

(51) Int. Cl. B25B 23/142; B25B 23/16

(52) U.S. Cl. CPC B25B 23/1425; B25B 23/16

(57) ABSTRACT

A display housing assembly has a base, a lens, and buttons. The base, lens, and buttons may be shaped to correspond with an external geometry of a tool housing, such as, for example, curved, arcuate or cylindrically shaped. The display housing assembly may also be assembled by molding the lens, molding the base over the lens, and molding the buttons over the base.

### TECHNICAL FIELD OF THE INVENTION

The present invention relates generally to a display housing assembly for a tool.

### BACKGROUND OF THE INVENTION

Display assemblies, such as, for example, LCD and LED displays, are often used in hand tools, such as motorized ratchet wrenches and drivers, that are commonly used in automotive, industrial, and household applications to tighten and untighten work pieces, such as threaded fasteners, and to apply a torque and/or angular displacement to a work piece, for example. Hand tools, such as power ratchets and drivers, generally include a motor contained in a cylindrically shaped housing, along with other components such as switches, printed circuit boards (PCBs), and a power source (e.g., battery), for example. Accordingly, housings of the hand tools require space to accommodate all the components needed to operate these tools, especially for hand tools that use brushless DC electric motors. Typically, display assemblies have separate buttons and flat displays. The tool housing thus must include space to accommodate additional structure for the buttons and have a shape to accommodate the flat display, which creates a bulkier housing for a user to operate in tight spaces.

### SUMMARY OF THE INVENTION

The present invention relates broadly to a display housing assembly for a display unit, such as an LCD or LED. The display housing assembly includes a base, a lens, and buttons. The display unit, base, lens, and buttons are shaped to correspond with an external geometry of the tool housing, such as, for example, arcuate or cylindrically shaped. The display housing assembly is made by molding the lens, then molding the base over the lens, and then molding the buttons over the base. By molding the base over the lens, and molding the buttons over the base, the display housing assembly includes integrated buttons and is easier to manufacture and assemble, compared to current solutions. Also, by having the buttons integrated with the display housing assembly, less space to accommodate additional structure for the buttons is needed. The display housing assembly can further be shaped to correspond with an external geometry of the tool housing, such as, for example, curved, arcuate or cylindrically shaped, thereby resulting in a more compact tool housing.

In an embodiment, the present invention broadly comprises a tool housing for a tool. The tool housing including a display unit and a display housing assembly adapted to be coupled to the tool housing. The display housing assembly includes a lens and a base molded over the lens.

In another embodiment, the present invention broadly comprises a tool. The tool includes a tool housing portion, a display unit disposed in the tool housing portion, and a display housing assembly coupled to the tool housing portion. The display housing assembly includes a lens and a base molded over the lens.

In another embodiment, the present invention broadly comprises a display housing assembly. The display housing assembly housing includes a lens and a base molded over the lens.

In another embodiment, the present invention broadly comprises a method of making a display housing assembly. The method includes molding a lens, molding a base over the lens, and molding buttons over the base.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplar tool, such as a motorized ratchet tool, including a display housing assembly in accordance with an embodiment of the present invention.

FIG. 2 is a perspective view of an exemplar display housing assembly, according to an embodiment of the present invention.

FIG. 3 is a front view of a base of the display housing assembly of FIG. 2, according to an embodiment of the present invention.

FIG. 4 is a rear view of the base of FIG. 3.

FIG. 5 is a front view of exemplar buttons of the display housing assembly of FIG. 2, according to an embodiment of the present invention.

FIG. 6 is a rear view of the exemplar buttons of FIG. 5.

FIG. 7 is a bottom view of the exemplar buttons of FIG. 5.

FIG. 8 is a front view of a lens of the display housing assembly of FIG. 2, according to an embodiment of the present invention.

FIG. 9 is a bottom view of the lens of FIG. 8.

FIG. 10 is a flow diagram illustrating a method of manufacturing a display housing assembly, in accordance with an embodiment of the present invention.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention broadly includes a display housing assembly for a display unit, such as an LCD or LED. In an embodiment, the display housing assembly is disposed in a motorized hand tool, such as, for example, a motorized ratchet tool. The display housing assembly includes a base, a lens, and buttons. The base, lens, and buttons are shaped to correspond with an external geometry of the tool housing, such as, for example, curved, arcuate or cylindrically shaped. The display housing assembly is made by molding the lens, molding the base over the lens, and molding the buttons over the base.

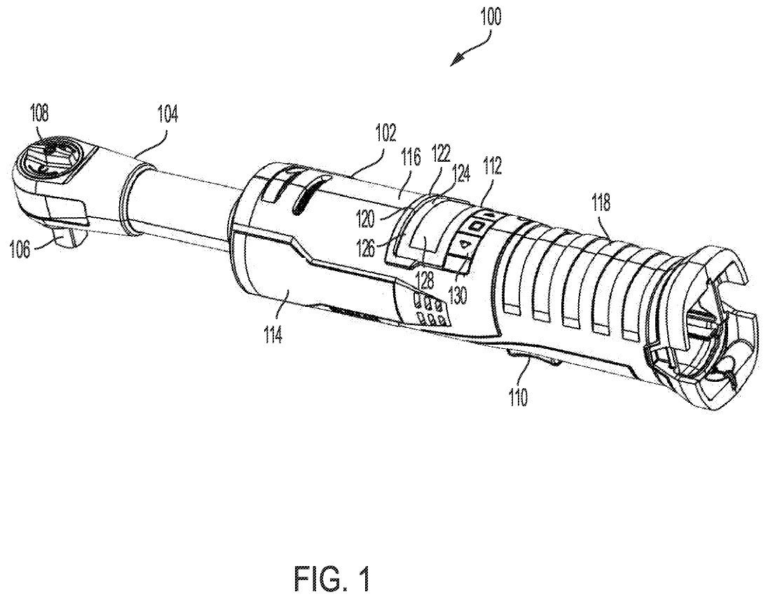

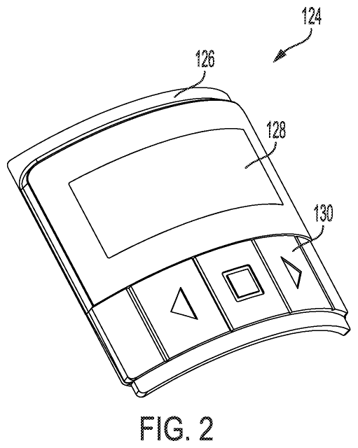

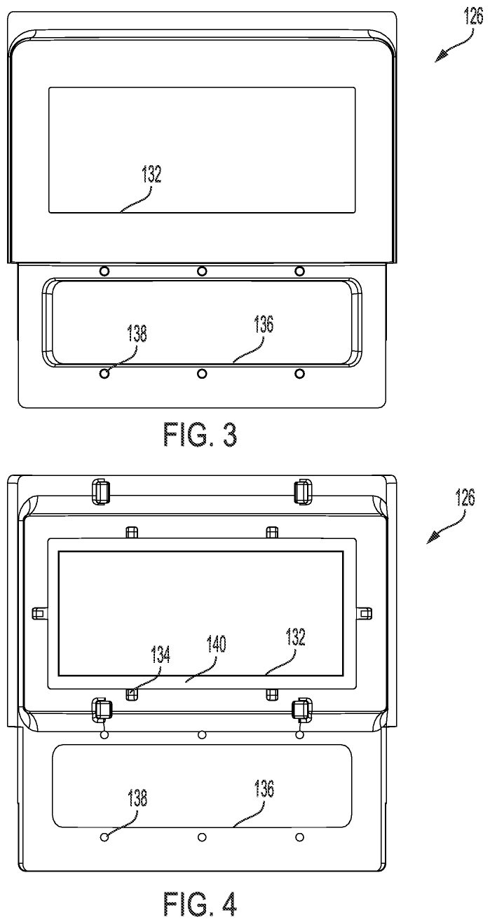

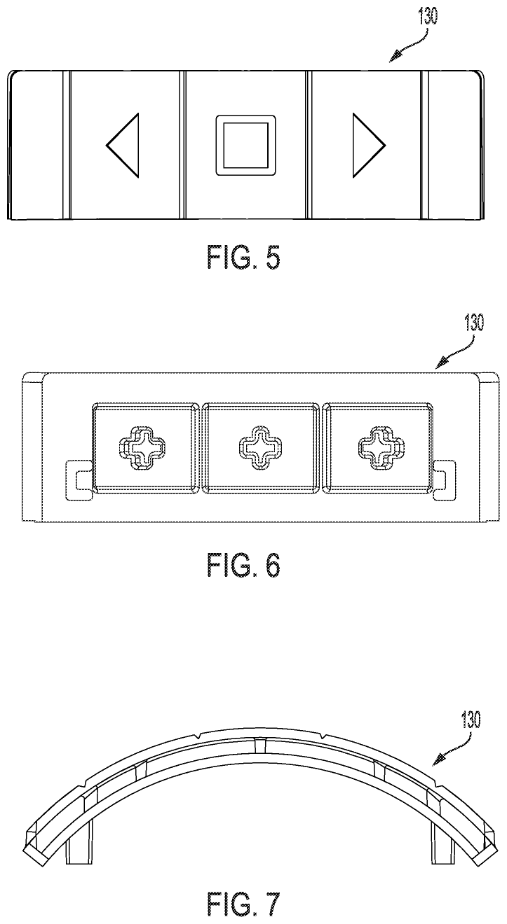

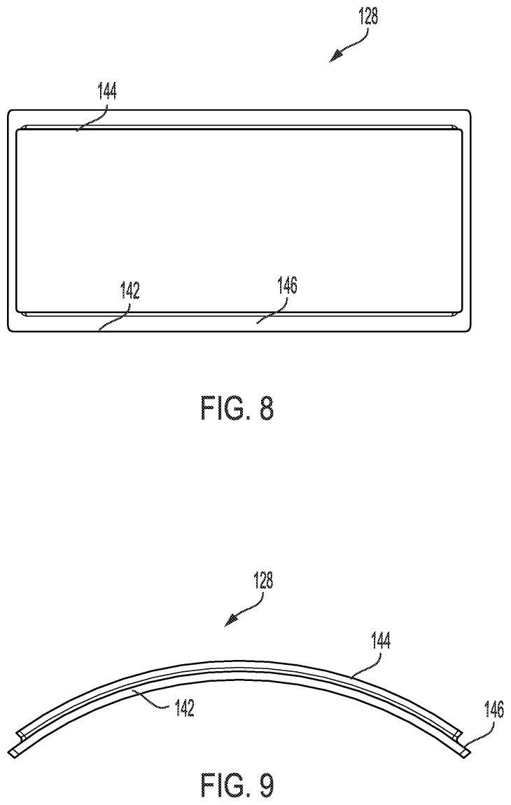

Referring to FIGS. 1-9, a tool 100, such as, for example, a motorized ratchet tool, includes a tool housing portion 102 adapted to be held by a user and a driver portion 104 coupled to the tool housing portion 102. The driver portion 104 is adapted to apply torque to a work piece and includes a drive lug 106 adapted to engage a tool (e.g., socket or bit) to drive the work piece, for example, in a well-known manner. The drive lug 106 is operatively coupled to and driven by a motor (not shown) via a ratcheting mechanism (not shown) of the driver portion 104 in a well-known manner. The driver portion 104 also includes a selector knob 108 adapted to select a rotational drive direction of the drive lug 106 (i.e., clockwise or counter-clockwise). In an embodiment, the driver portion 104 is a ratchet head of a ratchet tool.

The tool housing portion 102 operably houses one or more of the motor adapted to drive the drive lug 106, a trigger 110 adapted to actuate the motor, a power source (not shown) adapted to provide electrical power for the motor, such as a battery, one or more PCBs for motor and/or display control, and a display assembly 112 (described in more detail below). In an embodiment, the housing portion 102 is assembled from first and second clamshell housing portions 114, 116 coupled together to cooperatively form the tool housing portion 102. The housing portion 102 may also include a handle portion 118 that a user may grip or hold during operation of the tool 100.

The first and second clamshell housing portions 114, 116 are configured to couple together and couple the driver assembly 104 to the tool 100. When assembled, as shown in FIG. 1, for example, the first and second clamshell housing portions 114, 116 retain the display assembly 112 therein. In an embodiment, the first and second clamshell housing portions 114, 116 cooperatively form a display opening 120 when coupled together. The display opening 120 includes a peripheral lip 122 disposed at least partially around the perimeter of the display opening 120 to retain the display assembly 112 in the first and second clamshell housing portions 114, 116.

The motor can be, for example, an electric motor electrically coupled to the power source via the trigger 110. The power source can be external (e.g., an electrical wall outlet, generator, external battery, etc.) or internal (e.g., a removable and rechargeable battery). The trigger 110 can be adapted to cause the motor to be turned ON and OFF, or cause electric power/voltage to flow from the power source to the motor or cease flow from the power source to the motor.

The trigger 110 can be an actuation mechanism that employs a push button actuator or other type of actuator. For example, the user can depress the trigger 110 inwardly to selectively cause power to be supplied from the power source to cause the motor to operate and provide torque to the driver assembly 104 in a desired rotational direction. Any suitable trigger 110 or switch can be implemented without departing from the spirit and scope of the present invention. For example, the trigger 110 can be a toggle actuator, a touch sensitive actuator, a slide actuator, or other suitable actuator or device. In another example, the trigger 110 can be biased such that the trigger 110 is depressible inwardly, relative to the tool housing portion 102, to cause the tool 100 to operate, and releasing the trigger 110 causes the trigger 110 to move outwardly, relative to the tool housing portion 102, to cease operation of the tool 100 via the biased nature of the trigger 110. The trigger 110 may also be a variable speed type mechanism. In this regard, relative actuation or depression of the trigger 110 causes the motor to operate at variable speeds, depending on the depression level of the trigger 110.

The display assembly 112 includes a display housing assembly 124 that houses and protects a display unit (not shown). In an embodiment, the display housing assembly 124 includes a base 126, a lens 128, and buttons 130. In an embodiment, the display assembly 124 may include touch-sensitive areas, so that separate buttons 130 are unnecessary. In such embodiment, selection of tool settings can be accomplished through the touch-sensitive display. In an embodiment, the display assembly 112 has a shape that substantially corresponds to an external geometry of the tool housing portion 102. For example, each of the display unit, display housing assembly 124, base 126, lens 128, and buttons 130 is curved, arcuate, or cylindrically shaped.

The base 126 is molded over the lens 128. In an embodiment, the base 126 is a glass-filled polymer, such as, for example, black glass-filled nylon. However, the invention is not limited as such and any other suitable moldable material may be used. The base 126 includes a lens opening 132 adapted to retain the lens 128 therein to allow the display unit to be viewed by a user. In an embodiment, notches 134 are disposed around the lens opening 132 to allow the lens 128 to be held inside the mold as the base 126 is molded over the lens 128 by the molder. Although six notches 134 are illustrated, any suitable number of notches 134 can be used. The base 126 may further includes a button opening 136 to allow the buttons 130 to pass therethrough. In an embodiment, apertures 138 are disposed around the button opening 136. The apertures 138 allow the material of the buttons 130 to passed therethrough when the buttons are molded over the base 126 to ensure the buttons 130 are mechanically coupled to the base 126. Although six apertures 138 are illustrated, any suitable number of apertures 138 can be used. In another embodiment, a recess 140 is disposed at least partially around the lens opening 132.

The lens 128 is a substantially clear lens and is made of a synthetic polymer, such as, for example, nylon. In an embodiment, the lens 128 includes first 142 and second 144 components or layers. For example, the first 142 and second 144 components or layers include one or more of light guide(s), substrate(s), polarizer(s), diffuser(s), reflector(s), etc. In an embodiment, the first component or layer 142 forms a peripheral lip 146 that substantially surrounds the second component or layer 144 and is shaped to substantially correspond to the recess 140.

In an embodiment, the buttons 130 are molded around the base 126 and through the apertures 138 and button opening 136 of the base 126, thereby maximizing contact area between these two components to ensure a good mechanical coupling therebetween.

Accordingly, the buttons 130 are relatively difficult to remove from the base 126 once assembled. The buttons 130 can be made of an elastomer material, such as, for example, rubber. Although three buttons are illustrated, any suitable number of buttons can be used. The buttons 130 are electrically coupled to the display unit via a PCB in a well-known manner and are adapted to receive a user input, such as, for example, selecting what is to be shown on the display unit, for selecting tool parameters, such as, for example, the driving direction of the drive lug 106, and/or for otherwise manipulating the display unit to control the tool 100 and/or parameters of the tool 100.

The display unit is adapted to indicate tool information to the user. In an embodiment, the display unit is an LCD or LED display unit. The tool information can include, for example, a tool status, such as, for example, a power level of the power source, a selected driving direction of the drive lug 106, a power state of the motor, output torque of the tool 100, etc. The display unit can further include a display driver adapted to generate signals with suitable voltage, current, timing and demultiplexing to cause the display unit to show the desired text or image in a well-known manner.

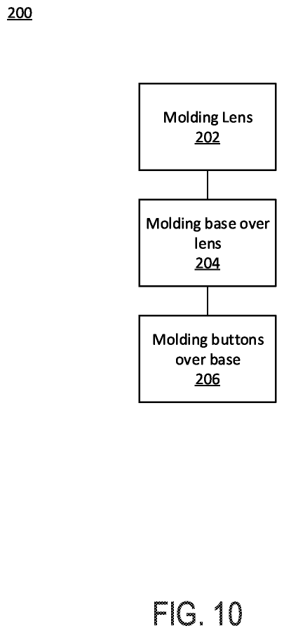

An embodiment of a method 200 of manufacturing a display housing assembly 100 is shown in FIG. 10. The method, at step 202, includes molding the lens 128. As stated above, the lens 128 can be made of a synthetic polymer, such as nylon or other suitable material, and is substantially clear.

The method, at step 204, includes molding the base 126 over the lens 128. As stated above, the base 126 can be made of a glass-filled polymer, such as black glass-filled nylon or other suitable material, and includes a lens opening 132, a button opening 136, and apertures 138.

The method, at step 206, includes molding the buttons 130 around the base 126. As stated above, the buttons 130 are molded such that the material of the buttons passes through the apertures 138 and the button opening 136 to restrict removal of the buttons 130 from the base 126. Further, as stated above, the buttons 130 are composed of an elastomer material, such as rubber or other suitable material.

As discussed above, the aspects of the present invention are described in terms of a motorized ratchet tool, as shown. However, it should be understood that aspects of the present invention could be implanted in other hand tools or implements. For example, and without limitation, the hand tool can be ratchet wrench, open wrench, screw driver, nut driver, drill, or any other tool capable of applying torque to a work piece.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool housing for a tool comprising:
a display unit; and
a display housing assembly adapted to be coupled to the tool housing, the display housing assembly includes a lens and a base molded over the lens.

2. The tool housing of claim 1, wherein the display housing assembly further includes buttons molded over the base.

3. The tool housing of claim 1, wherein each of the lens and base has a shape that substantially corresponds to an external geometry of the tool housing.

4. The tool housing of claim 1, wherein each of the lens and base has a curved shape.

5. The tool housing of claim 1, wherein the display unit is one of either an LCD or LED display.

6. The tool housing of claim 1, wherein the lens includes first and second layers.

7. The tool housing of claim 6, wherein the first layer forms a peripheral lip that substantially surrounds the second layer.

8. The tool housing of claim 1, wherein the lens is composed of a nylon material.

9. The tool housing of claim 1, wherein the base includes a lens opening adapted to retain the lens and a button opening.

10. A display housing assembly comprising:
a lens; and
a base molded over the lens.

11. The display housing assembly of claim 10, further comprising buttons molded over the base.

12. The display housing assembly of claim 10, wherein each of the lens and base has a curved shape.

13. The display housing assembly of claim 10, wherein the lens includes first and second layers.

14. The display housing assembly of claim 13, wherein the first layer forms a peripheral lip that substantially surrounds the second layer.

15. The display housing assembly of claim 10, wherein the base includes a lens opening adapted to retain the lens and a button opening.

16. The display housing assembly of claim 15, wherein the base includes notches disposed adjacent to the lens opening and apertures disposed adjacent the button opening.

17. The display housing assembly of claim 16, wherein the buttons pass through the button opening and apertures.

18. A method of manufacturing a display housing assembly, the method comprising:
molding a lens;
molding a base over the lens; and
molding buttons over the base.

19. The method of claim 18, wherein the base includes a lens opening, a button opening, notches disposed adjacent the lens opening, and apertures disposed adjacent the button opening.

20. The method of claim 19, wherein the step of molding buttons over the base includes forming the buttons around the base and through the button opening and apertures.
